(19) United States
(12) Patent Application Publication
(10) Pub. No.: US 2007/0188404 A1
(43) Pub. Date: Aug. 16, 2007

(54) Information processing apparatus

(75) Inventor: Young Chuel Cha, Dalseo-gu (KR)

Correspondence Address: KED & ASSOCIATES, LLP, P.O. Box 221200, Chantilly, VA, 20153-1200, US

(73) Assignee: LG Electronics Inc.

(21) Appl. No.: 11/637,776

(22) Filed: Dec. 13, 2006

(30) Foreign Application Priority Data
Feb. 16, 2006 (KR) 10-2006-0015032

(51) Int. Cl. G09G 5/00

(52) U.S. Cl. 345/1.1

(57) ABSTRACT

The present invention relates to an information processing apparatus having panels formed inside and outside of its covering member. The information processing apparatus includes a body, a covering member, a first panel, a second panel, a first driver and a second driver. The covering member covers the body. The first panel is formed on an internal surface of the covering member. The second panel is formed on an external surface of the covering member. The first driver drives the first panel. The second driver drives the second panel. Here, at least one of the first driver and the second driver drives corresponding panel. The information processing apparatus includes a second panel formed on an outside surface of a covering member, and so the consumption of a battery is reduced.

### CROSS-REFERENCE TO RELATED APPLICATIONS

This application claims priority from Korean Patent Application No. 2006-15032, filed on Feb. 16, 2006, the contents of which are incorporated herein by reference in its entirety.

### BACKGROUND OF THE INVENTION

1. Field of the Invention

The present invention relates to an information processing apparatus. More particularly, the present invention relates to an information processing apparatus having panels formed inside and outside of its covering member.

2. Description of the Related Art

An information processing apparatus processes information in accordance with a certain program, for example is portable laptop computer. Generally, the laptop computer includes a body and a covering member for covering the body. Here, a panel is formed inside the covering member, and displays a certain image in accordance with a specific program.

Hereinafter, a process of driving the laptop computer will be described in detail.

Firstly, a user opens the laptop computer, and then starts its system by pushing a power button.

Subsequently, the laptop computer boots its system with windows OS (operating system) that is a united operating system in accordance with the power button, thereby displaying a first screen.

Then, the laptop computer drives a certain program in accordance with handling of key buttons by the user.

In brief, the laptop computer drives always its system with windows OS that is a united operating system, and so its system operates stably. However, much time is required for driving a certain program by using the united operating system. In other words, a certain program could be simply driven without using the windows OS that is a united operating system, but the laptop computer drives a specific program with the windows OS irrespective of program. Accordingly, much time is required for driving the specific program.

In addition, the laptop computer is used under the condition of opening, and so it is difficult to use the laptop computer when the laptop computer is located in narrow space, or when the user using the laptop computer moves, and so on.

### SUMMARY OF THE INVENTION

It is a feature of the present invention to provide an information processing apparatus, especially laptop computer for displaying rapidly an image in accordance with a specific program by using panel formed outside of the information processing apparatus.

It is a feature of present invention to provide an information processing apparatus, especially laptop computer for driving a certain program under the condition of closing of the information processing apparatus.

An information processing apparatus according to one embodiment of the present invention includes a body, a covering member, a first panel, a second panel, a first driver and a second driver. The covering member covers the body. The first panel is formed on an internal surface of the covering member. The second panel is formed on an external surface of the covering member. The first driver drives the first panel. The second driver drives the second panel. Here, at least one of the first driver and the second driver drives corresponding panel.

A laptop computer according to one embodiment of the present invention includes a body, a coveting member, a first organic electroluminescent device and a second organic electroluminescent device. The covering member covers the body. The first organic electroluminescent device is formed on an internal surface of the covering member. The second organic electroluminescent device is formed on an external surface of the covering member. Here, only the second organic electroluminescent device of the organic electroluminescent devices operates under the condition of closing the laptop computer.

As described above, an information processing apparatus of the present invention includes a second panel formed on an outside surface of a covering member, and so the consumption of a battery is reduced. In addition, it is easy to use the information processing apparatus when a user moves.

Additionally, the information processing apparatus of the present invention drives various program using only a second panel formed on an outside surface of a covering member without using a first panel formed inside of the covering member under the condition of closing of the information processing apparatus, and so the information processing apparatus may drive various programs with a minimum space. That is, when the second panel is driven with a individual operating system, the processing velocity of the information processing apparatus is enhanced.

### BRIEF DESCRIPTION OF THE DRAWINGS

The above and other features and advantages of the present invention will become readily apparent by reference to the following detailed description when considered in conjunction with the accompanying drawings wherein:

FIG. 1A is a prospective view illustrating an information processing apparatus, preferably laptop computer under the condition of its opening according to one embodiment of the present invention;

FIG. 1B and FIG. 1C are perspective views illustrating the laptop computer under the condition of its closing according to one embodiment of the present invention;

FIG. 2 is a block diagram illustrating the information processing apparatus, preferably laptop computer according to one embodiment of the present invention;

FIG. 3A is a view illustrating the second driver and the second panel of FIG. 2 according to one embodiment of the present invention;

FIG. 3B is a sectional view illustrating one pixel of FIG. 3A;

FIG. 4 is a block diagram illustrating the information processing apparatus, preferably laptop computer according to another embodiment of the present invention;

FIG. 5 is a view illustrating the information processing apparatus, preferably laptop computer according to still another embodiment of the present invention; and

FIG. 6 is a plan view illustrating screen displayed on the second panel according to one embodiment of the present invention.

### DESCRIPTION OF EMBODIMENTS

Hereinafter, the preferred embodiments of the present invention will be explained in more detail with reference to the accompanying drawings.

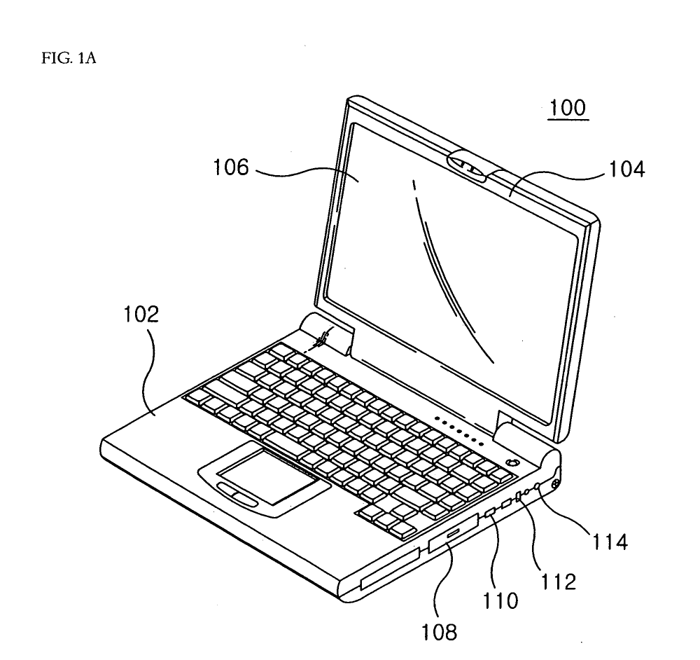

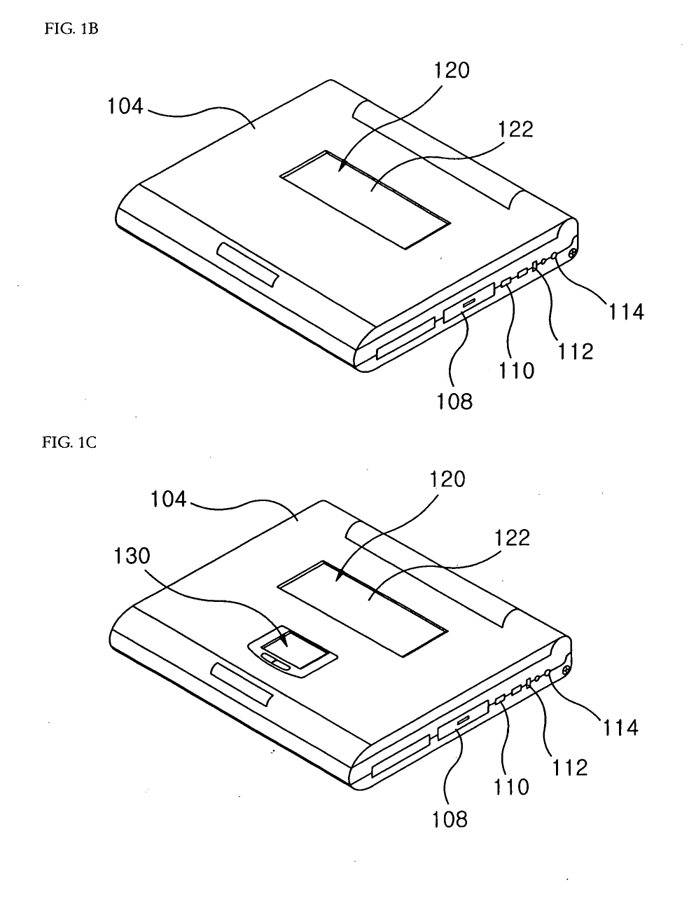

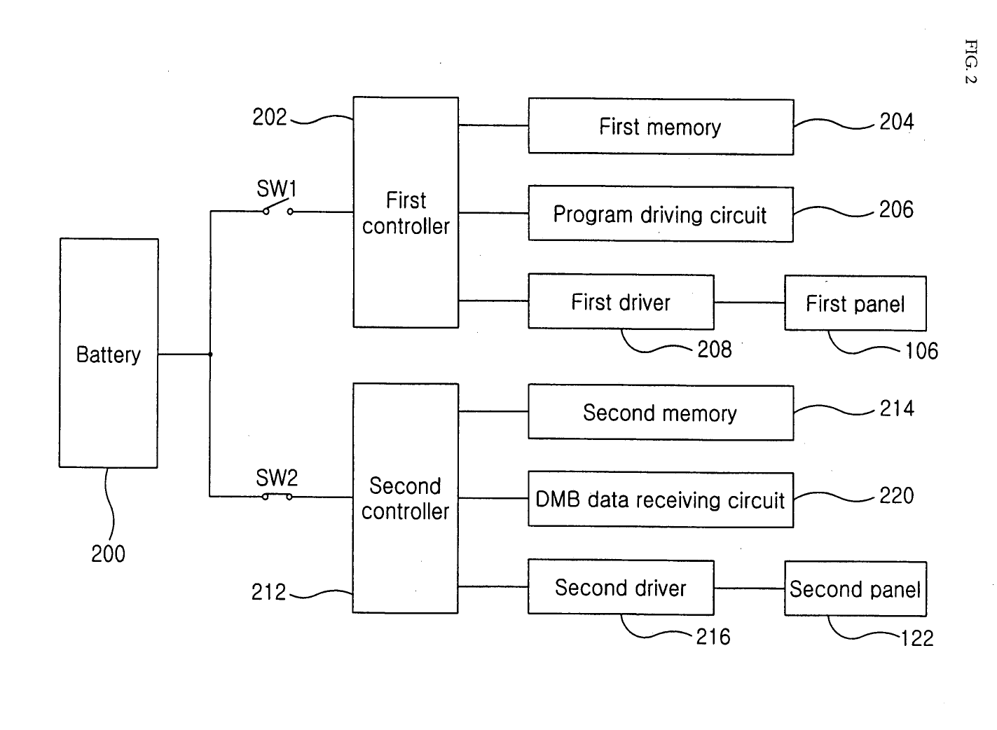

FIG. 1A is a prospective view illustrating an information processing apparatus, preferably laptop computer under the condition of its opening according to one embodiment of the present invention. FIG. 1B and FIG. 1C are perspective views illustrating the laptop computer under the condition of its closing according to one embodiment of the present invention.

In FIG. 1A to FIG. 1C, the information processing apparatus 100 of the present invention indicates apparatus capable of processing information such as laptop computer, etc., and includes a body 102 and a covering member 104 for covering the body 102. Hereinafter, the laptop computer will be described as an example of the information processing apparatus 100 for convenience of the description.

Key pads and a mouse, etc. are disposed on an upper surface of the body 102 as shown in FIG. 1A. A CD inserting member 108 where CD and DVD disk are inserted, USB port 110 and outside terminal 114 is disposed at side of the body 102.

A first panel 106 is formed on an inside surface of the covering member 104 as shown in FIG. 1A, and a second panel 122 is formed on an outside surface of the covering member 104 as shown in FIG. 1B. In addition, a mouse pad 130 may be formed with the second panel 122 on the outside surface of the covering member 104 as shown in FIG. 1C.

The first panel 106 as main panel displays a screen according as a user handles the keypads and a first mouse pad formed on the upper surface of the body 102, wherein the screen corresponds to the handling.

The second panel 122 as sub-panel is driven by using for example, a touch screen method or handling a second mouse pad 130, and has size smaller than the first panel 106.

In addition, the second panel 122 is formed in a recess 120 as shown in FIG. 1B in order to protect the second panel 122 from outside impact. In another embodiment, the second panel 122 is formed on the outside surface of the covering member 104, and a protecting film (not shown) may be attached on an outside surface of the covering member 104.

The panels 106 and 122 may be made up of various display devices such as liquid crystal display (LCD), plasma display panel (PDP), and organic electroluminescent device, etc.

However, the organic electroluminescent device has excellent characteristics than the other display devices as described below, and so it is desirable that the panels 106 and 122 are made up of organic electroluminescent devices.

Hereinafter, the characteristics of the organic electroluminescent device and the characteristics of the other display devices will be compared.

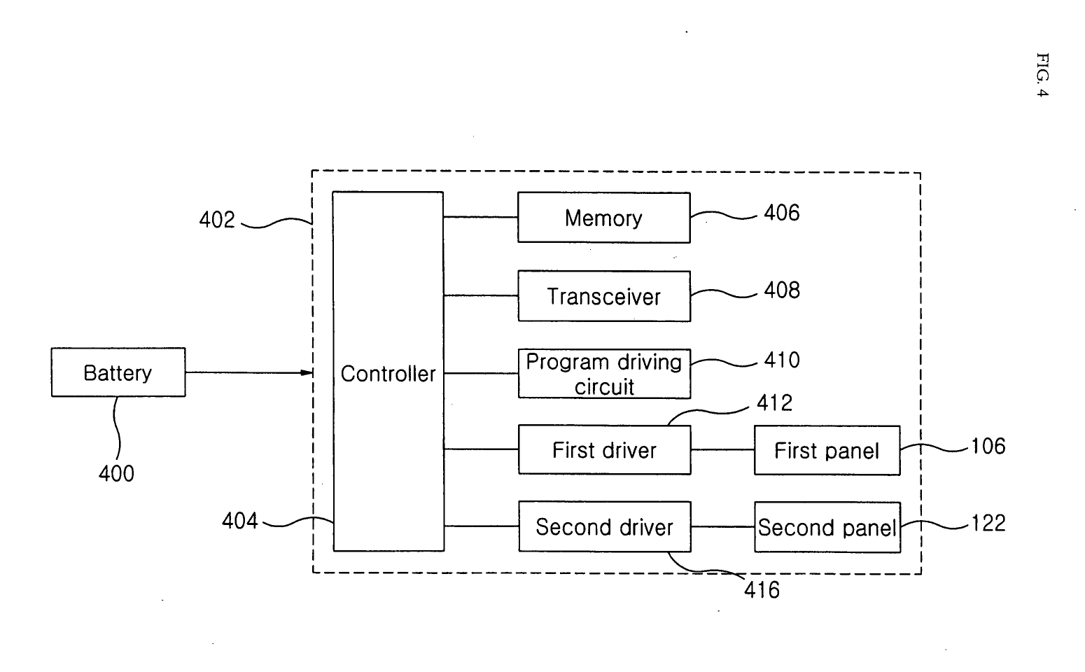

The LCD and the PDP are not self light-emitting device, and so assisting device such as backlight unit, etc. is required for the LCD and the PDP Whereas, the organic electroluminescent device is self light-emitting device as shown in FIG. 3B, and so assisting device is not required for the organic electroluminescent device. That is, because the organic electroluminescent device is self light-emitting device, the processing velocity of the organic electroluminescent device is faster than the other display devices. Further, the organic electroluminescent device does not include assisting device such as backlight unit, etc., and thus the thickness of the organic electroluminescent device is smaller than that of the other display devices. Accordingly, it is desirable that the panels 106 and 122 are made up of organic electroluminescent devices.

Hereinafter, the operation of the laptop computer 100 when the laptop computer 100 is open or closed will be described in detail.

Firstly, in the laptop computer 100, the first panel 106 and devices related to the first panel 106 are operated in case that the laptop computer 100 is open as shown in FIG. 1A, and the second panel 122 and devices related to the second panel 122 are turned off. In this case, the laptop computer 100 drives the first panel 106 and the devices related to the first panel 106 by using a united operating system, e.g. windows OS. For another example, in case that the laptop computer 100 is open, the laptop computer 100 operates both of the first panel 106 and the second panel 122 so that other people except user using the laptop computer 100 sees an image displayed on the second panel 122. In this case, the first panel 106 and the second panel 122 display a same image or different image.

Next, in case that the laptop computer 100 is closed as shown in FIG. 1B and FIG. 1C, the operation of the laptop computer 100 will be described.

First, in case that the laptop computer 100 operates under the condition of closing since the laptop computer 100 is booted under the condition of its closing, the first panel 106 and the devices related to the first panel 106 are turned off, but the second panel 122 and the devices related to the second panel 122 operate. For instance, when the user wants to view digital multimedia broadcasting (DMB) and DVD during the moving, the laptop computer 100 drives the second panel 122 and the devices related to the second panel 122 without driving the first panel 106, thereby displaying DMB, etc. on the second panel 122. In other words, in case that the user need not to use the first panel 106 formed inside the covering member 104 and the devices related to the first panel 106, the user employs only the second panel 122 and the devices related to the second panel 122 under the condition of closing of the laptop computer 100.

As mentioned above, in case that the laptop computer 100 operates under the condition of closing since the laptop computer 100 is booted under the condition of its closing, the laptop computer 100 drives its system with program for driving only DMB or DVD, i.e. individual operating system without using united operating system such as windows OS, etc. so as to enhance display velocity of the second panel 122. In other words, the operating system when the laptop computer 100 is closed is different from that when the laptop computer 100 is open, and is preferably individual operating system having processing velocity faster than united operating system. However, the laptop computer 100 may drive its system with the united operating system.

Second, in case that the laptop computer 100 operates under the condition of its opening and then is closed, the second panel 122 and the devices related to the second panel 122 continuously operate, but the first panel 106 and the devices related to the first panel 106 are changed into standby status. For example, DMB is displayed on the second panel 122, and the first panel 106 is turned off. In this case, the devices related to the first panel 106 keep its present operation, and so an image prior to closing of the laptop computer 100 is again displayed on the first panel 106 when the laptop computer 100 is re-open.

In another embodiment, in case that the laptop computer 100 operates under the condition of its opening and then is closed, the first panel 106 may keep its present condition.

On the other hand, in case that the laptop computer 100 operates under the condition of its opening, the laptop computer 100 drives its system with the united operating system. Accordingly, in case that the laptop computer 100 operates under the condition of its opening and then is closed, it is desirable that the laptop computer 100 drives the second panel 122 and the devices related to the second panel 122 with the united operating system. However, in this case, the laptop computer 100 may drive the second panel 122 and the devices related to the second panel 122 with the individual operating system.

The second panel 122 according to one embodiment of the present invention displays a certain image in accordance with outside signal inputted through the CD inserting member 108, the USB port 110 and the outside terminal 114, etc. disposed at the side of the body 102. Additionally, the second panel 122 and the devices related to the second panel 122 may be turned on by a power switch disposed at the side of the body 102.

In brief, the information processing apparatus 100 of the present invention displays DMB, etc. on the second panel 122 under the condition of its closing. In this case, the second panel 122 is driven by a specific individual operating system. Further, because a panel having large size is not required for viewing DMB, etc, the information processing apparatus 100 of the present invention uses the second panel 122 having size smaller than the first panel 106 so as to display DMB. Accordingly, unlike the information processing apparatus which uses always a first panel having large size in Related Art, the information processing apparatus 100 of the present invention may use the second panel 122 having small size when the user wants to view DMB, etc. Hence, the consumption of a battery employed in the information processing apparatus 100 of the present invention may be reduced.

Moreover, the user may use the information processing apparatus 100 under the condition of its closing, and thus space use efficiency and portability in using the information processing apparatus 100 may be enhanced.

That is, in case that the user uses the information processing apparatus 100 of the present invention, the user feels great convenience, and the consumption of the battery is reduced.

On the other hand, only DMB is described above, but DVD, PMP, MP3, and game, etc. may be performed through the second panel 122 in accordance with setting of the user. In other words, every type of programs capable of driving in accordance with outside signal inputted through the CD inserting member 108, the USB port 110 and the outside terminal 114, etc. may be driven in the condition of closing of the information processing apparatus 100

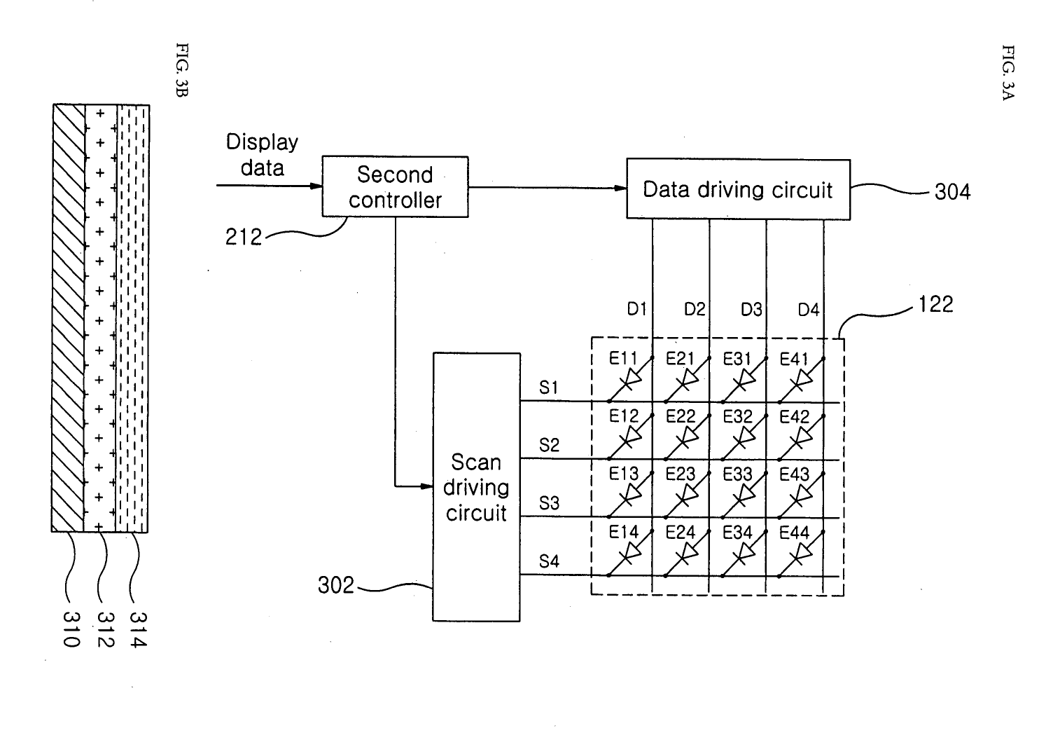

FIG. 2 is a block diagram illustrating the information processing apparatus, preferably laptop computer according to one embodiment of the present invention. Here, various programs may be driven on the second panel 122, but it is assumed that DMB is displayed on the second panel 122 for convenience of the description.

In FIG. 2, the information processing apparatus 100 of the present invention includes a battery 200, a first switch SW1, a second switch SW2, a first panel 106, devices related to the first panel 106, a second panel 122 and devices related to the second panel 122. In other words, the first panel 106 and the second panel 122 are driven separately.

The devices related to the first panel 106 have a first controller 202, a first memory 204, a program driving circuit 206 and a first driver 208. The devices related to the second panel 122 include a second controller 212, a second memory 214, a DMB data receiving circuit 220 and a second driver 216.

The first memory 204 stores various programs such as windows OS, etc.

The program driving circuit 206 drives the programs.

The first driver 208 drives the first panel 106 in accordance with driving of the program driving circuit 206, and so a certain image is displayed on the first panel 106.

The first controller 202 controls the first panel 106 and the devices related to the first panel 106.

The second memory 214 stores program related to image displayed on the second panel 122.

The DMB data receiving circuit 220 receives DMB data from a DMB server (not shown).

The second driver 216 drives the second panel 122 in accordance with the received DMB data, and so DMB corresponding to the DMB data is displayed on the second panel 122. In another embodiment, other program except DMB may be displayed on the second panel 122.

The second controller 212 controls the second panel 122 and the devices related to the second panel 122.

Hereinafter, operation of the switches SW1 and SW2 in accordance with the condition of the information processing apparatus 100 will be described in detail.

First, in case that the information processing apparatus 100 is open, at least one of the switches SW1 and SW2 is turned on, and a voltage outputted from the battery 200 is supplied to devices related to the turned-on switch

Second, in case that the information processing apparatus 100 is closed since booting, the first switch SW1 is turned off, and the second switch SW2 is turned on. Accordingly, a voltage outputted from the battery 200 is supplied to the second panel 122 and the devices related to the second panel 122.

Third, in case that the laptop computer 100 operates under the condition of its opening and then is closed, the switches SW1 and SW2 are turned on. Here, the first panel 106 is turned off, and the devices related to the first panel 106 keep operating. Accordingly, the first panel 106 is changed into standby status, and the second panel 122 displays a certain image.

As described above, one battery 200 is employed in the information processing apparatus 100. However, the information processing apparatus 100 may include a first battery for supplying the first panel 106 with a first voltage and a second battery for supplying the second panel 122 with a second voltage.

FIG. 3A is a view illustrating the second driver and the second panel of FIG. 2 according to one embodiment of the present invention. FIG. 3B is a sectional view illustrating one pixel of FIG. 3A.

In FIG. 3A, the second controller 212 receives display data inputted from an outside apparatus (not shown), and controls a scan driving circuit 302 and a data driving circuit 304 included in the second driver 216 using the received display data.

The scan driving circuit 302 transmits scan signals to scan lines S1 to S4 under control of the second controller 212, and so the scan lines S1 to S4 are coupled in sequence to a ground.

The data driving circuit 304 provides data signals, i.e. data currents corresponding to the display data transmitted from the second controller 212 to data lines D1 to D4.

The second panel 122 is made up of organic electroluminescent device, and includes a plurality of pixels E11 to E44 formed in cross areas of the data lines D1 to D4 and the scan lines S1 to S4.

One or more pixel includes an anode electrode layer 310, an organic layer 312 and a cathode electrode layer 314 as shown in FIG. 3B.

The anode electrode layer 310 as transparent electrode layer is made up of for example indium tin oxide.

The organic layer 312 is made up of organic material related to a specific color, and includes a hole transporting layer (HTL), an emitting layer (EML) and a electron transporting layer (ETL).

The cathode electrode layer 314 is made up of metal, e.g. aluminum (Al).

In case that a positive voltage and a negative voltage are provided to the anode electrode layer 310 and the cathode electrode layer 314, respectively, HTL transports holes generated from the anode electrode layer 310 to EML, and ETL transports electrodes generated from the cathode electrode layer 314 to EML. The transported holes and electrodes are recombined in EML, and so a light having a certain wavelength is emitted from EML.

In short, when the scan signals are transmitted to the scan lines S1 to S4 and the data currents are provided to the data lines D1 to D4, the pixels E11 to E44 emit light.

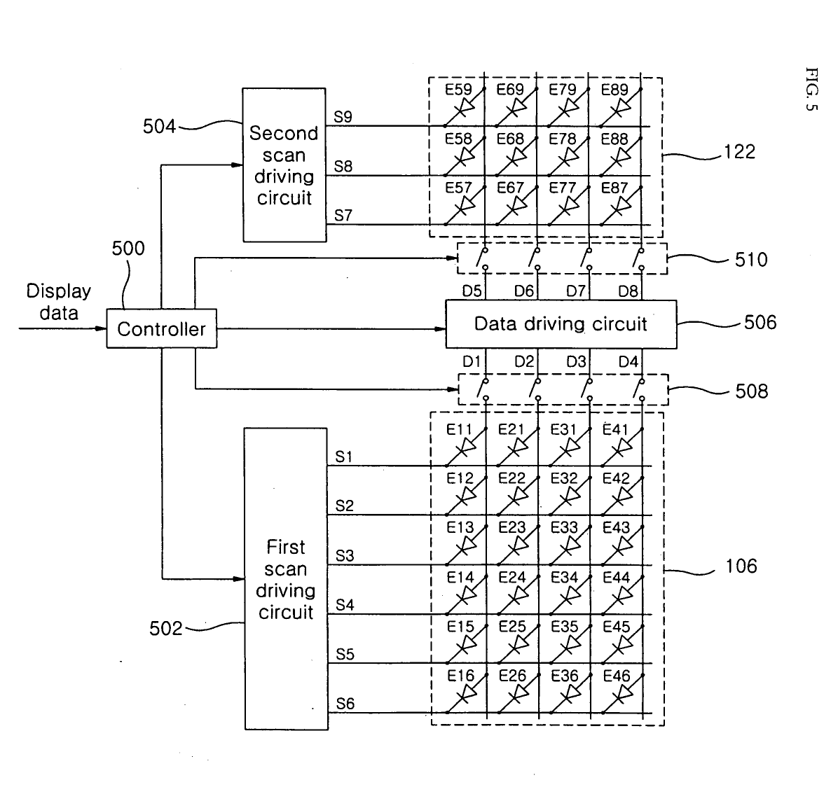

FIG. 4 is a block diagram illustrating the information processing apparatus, preferably laptop computer according to another embodiment of the present invention.

In FIG. 4, the information processing apparatus 100 includes a battery 400 and a driving circuit 402.

The driving circuit 402 is driven by voltage supplied from the battery 400, includes a controller 404, a memory 406, a transceiver 408, a program driving circuit 410, a firs driver 412, the first panel 106, a second driver 416 and the second panel 122.

The controller 400 controls elements of the information processing apparatus, and specially controls the first panel 106 and the second panel 122 together. In other words, the first panel 106 and the second panel 122 are controlled by one controller 404 unlike the panels 106 and 122 in FIG. 2. Here, a voltage outputted from the battery 400 is supplied to devices operated by control of the controller 404.

The memory 406 stores various programs and data required for operating of the information processing apparatus 100.

The transceiver 408 is interface, and receives data from a first outside apparatus or transmits data to a second outside apparatus.

The program driving circuit 410 makes various programs drive.

The first driver 412 and the second driver 416 drive the panels 106 and 122, and operate selectively or together by control of the controller 404.

As described above, the drivers 412 and 416 drive the panels 106 and 122, respectively. However, one driver may drive the panels 106 and 122.

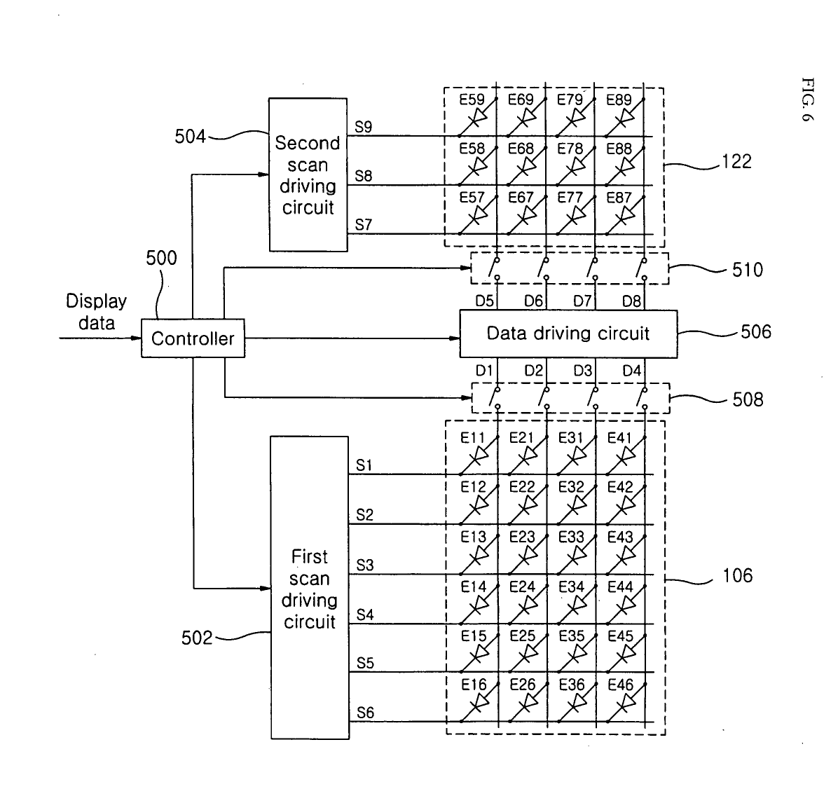

FIG. 5 is a view illustrating the information processing apparatus, preferably laptop computer according to still another embodiment of the present invention.

In FIG. 5, the information processing apparatus 100 includes a controller 500, the first panel 106, the second panel 122, a first scan driving circuit 502, a second scan driving circuit 504, a data driving circuit 506, a first switching circuit 508 and a second switching circuit 510.

The panels 106 and 122 are organic electroluminescent devices, and so the data driving circuit 506 may be shared unlike the other embodiments.

The first panel 106 includes first pixels E11 to E46 formed in cross areas of first data lines D1 to D4 and first scan lines S1 to S6. The second panel 122 includes second pixels E57 to E89 formed in cross areas of second data lines D5 to D8 and second scan lines S7 to S9.

The controller 500 receives display data from an outside apparatus, and controls the scan driving circuits 502 and 504, the data driving circuit 506 and the switching circuits 508 and 510 by using the received display data.

The first scan driving circuit 502 transmits first scan signals to the first scan lines S1 to S6 under control of the controller 500.

The second scan driving circuit 504 transmits second scan signals to the second scan lines S7 to S9 under control of the controller 500.

The first switching circuit 508 includes first switches which are switched by control of the controller 500, and switches couple of the first data lines D1 to D4 and the data driving circuit 506 under control of controller 500.

The second switching circuit 510 includes second switches which are switched by control of the controller 500, and switches couple of the second data lines D5 to D8 and the data driving circuit 506 in accordance with control of the controller 500.

The data driving circuit 506 transmits first data signals corresponding to the display data transmitted from the controller 500 to the first data lines D1 to D4, and transmits second data signals to the second data lines D5 to D8.

In brief, the information processing apparatus 100 of the present invention drives one of the first panel 106 and the second panel 122 under control of the controller 500, or drives both of the panels 106 and 122. In this case, since the data driving circuit 506 is shared, the information processing apparatus 100 has size smaller than that in the other embodiments.

FIG. 6 is a plan view illustrating screen displayed on the second panel according to one embodiment of the present invention.

In FIG. 6, in case that the second panel 122 is standby status, indicators for indicating condition of the information processing apparatus 100 are displayed on the second panel 122. Here, the information processing apparatus 100 is closed.

For example, the indicators such as a battery capacity indicating section 600, a wireless LAN on/off indicating section 602, a sound on/off indicating section 604, a first panel condition indicating section 606, or data, etc are displayed on the second panel 122. Here, setting of indicators may be variously modified by a user. Hence, it will be immediately obvious to those skilled in the art that many modifications for indicators do not have any effect to the scope of the present invention

In another embodiment, DMB is displayed on one screen of the second panel 122. In this case, the indicators may be displayed at upper section or lower section of screen with DMB.

From the preferred embodiments for the present invention, it is noted that modifications and variations can be made by a person skilled in the art in light of the above teachings. Therefore, it should be understood that changes may be made for a particular embodiment of the present invention within the scope and the spirit of the present invention outlined by the appended claims.

What is claimed is:

1. An information processing apparatus comprising:
a body;
a covering member configured to cover the body;
a first panel formed on an internal surface of the covering member;
a second panel formed on an external surface of the covering member;
a first driver configured to drive the first panel; and
a second driver configured to drive the second panel,
wherein at least one of the first driver and the second driver drives corresponding panel.

2. The information processing apparatus of claim 1, wherein at least one of the first panel and the second panel is organic electroluminescent device.

3. The information processing apparatus of claim 1, wherein only the second driver of the drivers operates when the information processing apparatus is closed.

4. The information processing apparatus of claim 1, wherein the first panel and the second panel display a same image when the first driver and the second driver operate.

5. The information processing apparatus of claim 1, wherein the first driver and the second driver share a data driving circuit.

6. The information processing apparatus of claim 1, wherein the second panel is placed in a recess formed on an external surface of the covering member.

7. The information processing apparatus of claim 1, further comprising:
a first battery configured to supply power source to the first panel; and
a second battery configured to supply power source to the second panel.

8. The information processing apparatus of claim 1, wherein the second panel is driven by a touch screen means.

9. The information processing apparatus of claim 1, wherein indicator is displayed on the second panel.

10. The information processing apparatus of claim 1, wherein a certain image is displayed on only the second panel of the panels when the information processing apparatus is closed.

11. The information processing apparatus of claim 1, wherein operating system of the information processing apparatus when the information processing apparatus is closed is different from that when the information processing apparatus is open.

12. The information processing apparatus of claim 11, wherein the second panel is driven by individual operating system when the information processing apparatus is closed.

13. The information processing apparatus of claim 1, wherein DMB broadcast is displayed on the second panel under the condition of closing of the information processing apparatus.

14. The information processing apparatus of claim 1, wherein DVD program is displayed on the second panel under the condition of closing of the information processing apparatus.

15. The information processing apparatus of claim 1, wherein music file is played through the second panel under the condition of closing the information processing apparatus.

16. The information processing apparatus of claim 1, further comprising:
a mouth pad formed on the external surface of the covering member, and configured to operate the second panel.

17. The information processing apparatus of claim 1, wherein the information processing apparatus is portable computer.

18. A laptop computer comprising:
a body;
a covering member configured to cover the body;
a first organic electroluminescent device formed on an internal surface of the covering member; and
a second organic electroluminescent device formed on an external surface of the covering member,
wherein only the second organic electroluminescent device of the organic electroluminescent devices operates under the condition of closing the laptop computer.

19. The laptop computer of claim 18, wherein the second organic electroluminescent device is driven by a touch screen means.

20. The laptop computer of claim 18, when operating system of the information processing apparatus under the condition of closing of the information processing apparatus is different from that under the condition of open of the information processing apparatus.

21. The laptop computer of claim 18, further comprising:
a first battery configured to supply power source to the first organic electroluminescent device; and
a second battery configured to supply power source to the second organic electroluminescent device.

22. The laptop computer of claim 18, further comprising:
a first driver configured to drive the first organic electroluminescent device; and
a second driver configured to drive the second organic electroluminescent device.

23. The laptop computer of claim 22, wherein the drivers share a data driving circuit.

24. The laptop computer of claim 18, further comprising:
a driver configured to drive the organic electroluminescent devices.
